(19) United States
(12) Patent Application Publication
(10) Pub. No.: US 2014/0217164 A1
(43) Pub. Date: Aug. 7, 2014

(54) System and method for downloading a live performance through use of a QR code

(71) Applicants: Ronald Sweeney, New York, NY (US); Jacques Sweeney, New York, NY (US); David Ross, New York, NY (US)

(72) Inventors: Ronald Sweeney, New York, NY (US); Jacques Sweeney, New York, NY (US); David Ross, New York, NY (US)

(21) Appl. No.: 13/756,598

(22) Filed: Feb. 1, 2013

(51) Int. Cl. G06F 17/30

(52) U.S. Cl. CPC G06F 17/30017
USPC 235/375

(57) ABSTRACT

A system and method for downloading a live performance held at a venue using a QR code comprising a server, including a memory, processor, and content management system, and a computer, including a memory, processor, scanner, and software. The content management system is stored in the memory and adapted to run on the processor of the server, and is adapted to provide a website, transmit a corresponding link to the computer, receive information from the computer relating to a QR code, and transmit data to the computer through the internet. The software is stored in the memory and adapted to run on the processor of the computer, and is adapted to scan a QR code, associate it with a link for a live performance download, communicate, through the internet, with the content management system, receive, from the content management system, data pertaining to the download; and download the live performance.

### FIELD OF THE INVENTION

The present invention relates to the use of a QR code during a live performance to instantaneously download the live event being heard. Through a smartphone, a user can scan a QR code supplied at a live concert event, and be taken automatically to a site which will allow for the download, whether for free or for a purchase, or the live music heard at the concert currently being attended.

### BACKGROUND OF THE INVENTION AND DISCLOSURE

Quick Response Codes (hereinafter “QR Codes”) are barcode-like arrangements of square dots of varying sizes, arranged in a square pattern on a white background, which contain encoded information.

Disclosed is a system for delivering live, concert recorded audio/music to an end user via the use of a displayed QR Code at a live concert event for an instant download of that live event. Specifically, a participant at a concert obtains a QR code at the live event. The QR code could be displayed on a large video screen, or could be placed on the tickets which provide entrance to the event or some other physical handout at the concert. Individuals can then scan the QR code by employing their mobile device to “read” the QR code. This, in turn, launches a mobile landing page where the participant can accept charges and confirm purchase via said mobile landing (if the music requires a purchase to be downloaded). Once the participant confirms the charges, the audio file(s) selected can be transferred via a wireless, digital feed providing the content exploited at the live event the participant is attending and or recently attended.

In one embodiment, the QR code is obtained from a brochure, ticket, or flyer distributed at a concert event, or at a screen display at the event. The participant employs a mobile phone to “read” the QR code which results in the download of the concert being attended or just recently attended. In this embodiment, the QR code can be activated and de-activated on a time scale which allows a user to access the download only during or directly after the concert attended.

In any embodiment, the live performance can be downloaded in exchange for funds with charges being billed to the participant's mobile device wireless carrier (Verizon, AT&T, etc). Charges can be accepted via credit card entry, or pre-registration with a money exchanger, such as Pay Pal or the concert organizer

The present invention is designed to enhance the satisfaction of users and participants at a live event by providing access to audio, video or other related content recorded at that live event that allows users to pay for, and download, that content. The live performance could be a concert, a sporting event, an opera with text feed, or any other performance.

As part of the present invention, artists and venues agree to record and upload the music/audio, video, or other related content being performed and/or listened to by audience members. The recorded file is stored then uploaded and to a mobile, web-based site that can be accessed via a mobile device. QR codes indicating the mobile site URLs at which the audio/video file can be accessed are displayed on large screens at the live event, on performance tickets, advertising posters, or other printed materials or displays. When the QR code is read by an event participant's cell phone and the URL accessed, the mobile site may send the participant a “acknowledge and accept charges” message/“check-out” option, corresponding to the access/downloading of the live recording audio file/music. When a participant sees a live event QR code, they simply scan the code with a scanning app on their iPhone, Android, Blackberry or any other camera-enabled smartphone. The QR code initiates a smartphone function linking to our mobile page allowing for live audio digital content to be downloaded from the web. Additional audio content supplied by the artist at a live event could be an audio track from a yet-to-be-released album. This method and process enables a participant attending a live performance to download a recording of the performance that they just attended (preferably after being charged a fee) and provides the user the opportunity to instantly hear/re-listen and/or view/re-view to the recorded live event, after that live event.

In addition to the QR code, a text redemption option or a vanity URL option may be displayed on a large display screen, ticket, or other tangible item at the live event, providing further options for a performance attendee to obtain the link to the download of the live event being attended. Therefore, a phone number and/or web address could be displayed alongside the QR code, so that a user may text or log on to purchase the live download of the event. In one embodiment of the present invention, the text redemption option or vanity URL may be used in lieu of the scannable QR code, for use by an event attendee who does not have a smart phone with which to scan the QR code, or a scanner application on their phone.

### SUMMARY OF THE INVENTION

A system and method for downloading a live performance held at a venue using a QR code comprising a server, including a memory, processor, and content management system, and a computer, including a memory, processor, scanner, and software. The content management system is stored in the memory and adapted to run on the processor of the server, and is adapted to provide a website, transmit a corresponding link to the computer, receive information from the computer relating to a QR code, and transmit data to the computer through the internet. The software is stored in the memory and adapted to run on the processor of the computer, and is adapted to scan a QR code, associate it with a link for a live performance download, communicate, through the internet, with the content management system, receive, from the content management system, data pertaining to the download; and download the live performance.

### BRIEF DESCRIPTION OF THE DRAWINGS

FIG. 1a depicts a QR code displayed on a large display screen at a live performance for scanning by concert attendees;

FIG. 1b depicts a mobile phone with the QR code having already been scanned;

FIG. 1c shows a mobile phone with the QR code having already been scanned, and showing a website link which is accessed through such QR code;

FIG. 2a depicts a concert ticket with a QR code displayed thereon;

FIG. 2b depicts a mobile phone scanning the QR code on the ticket shown in FIG. 2a;

FIG. 2c is an alternate version of the image shown in FIG. 1c;

FIG. 3 is a flowchart of the process embodied by the present invention;

FIG. 4 depicts the process flow of images shown on the mobile phone when used in conjunction with an embodiment of the present invention; and

FIG. 5 is a schematic diagram of an embodiment of the system of the present invention illustrating the connection between the QR code and wireless device.

### DETAILED DESCRIPTION OF THE DRAWINGS AND THE PREFERRED EMBODIMENT

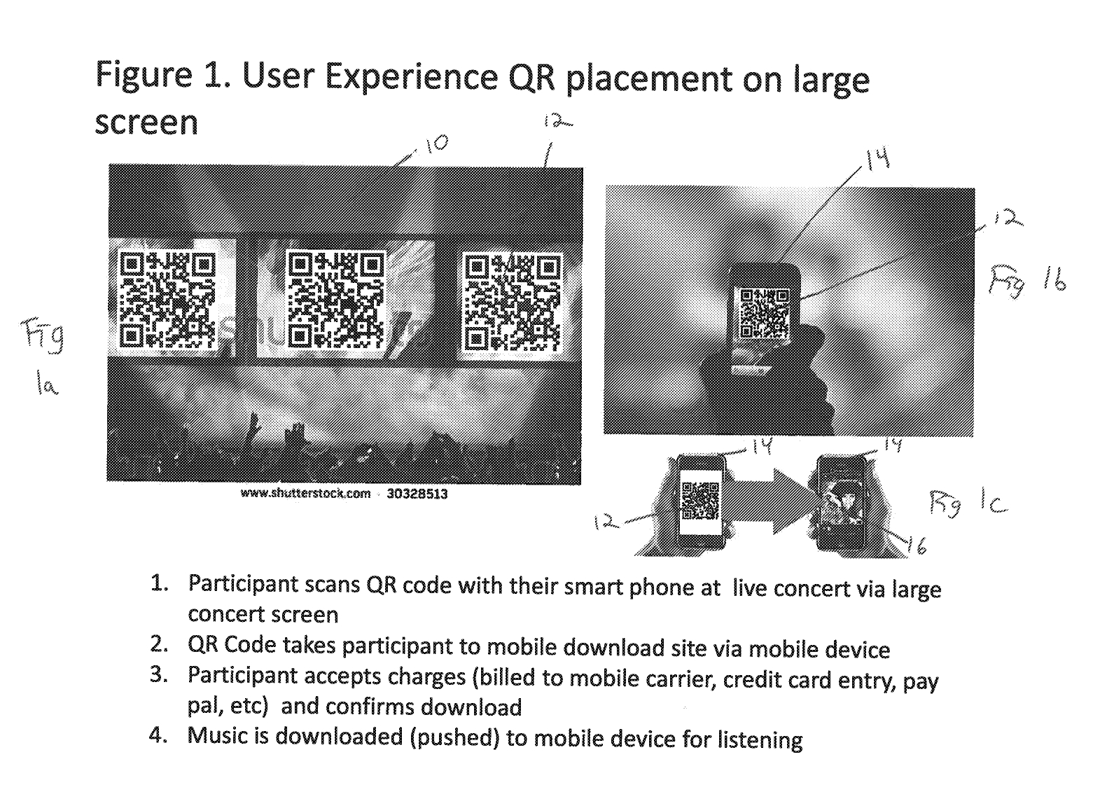

Description will now be given of embodiments of the invention with reference to the attached FIGS. 1-5. It should be understood that these figures are exemplary in nature and in no way serve to limit the scope of the invention as the invention will be defined by any claims, as interpreted by the Courts in an issued US Patent.

FIG. 1a depicts one embodiment of the present invention, showing the display of a QR code 12 on a large video screen 10 during a live performance attended. As shown, performance attendees can use their mobile phones 14 to scan the QR code during the performance. Upon scanning the QR code 12, as shown in FIG. 1b, the mobile phone 14 will access a link that brings users to a site 16 for the instant download. This procedure, from QR code to the download link, can be seen in FIG. 1c. Once this link is accessed, the user will be able to download a recording of the live event being attended. This event could be a concert, a sporting event, an opera with text feed, or any other live performance. The download, therefore, is only accessible to those actually attending the performance, and the download is not of pre-recorded performance, or an album of the artist's work—it is a live download of what is being heard and/or seen at the time of the performance.

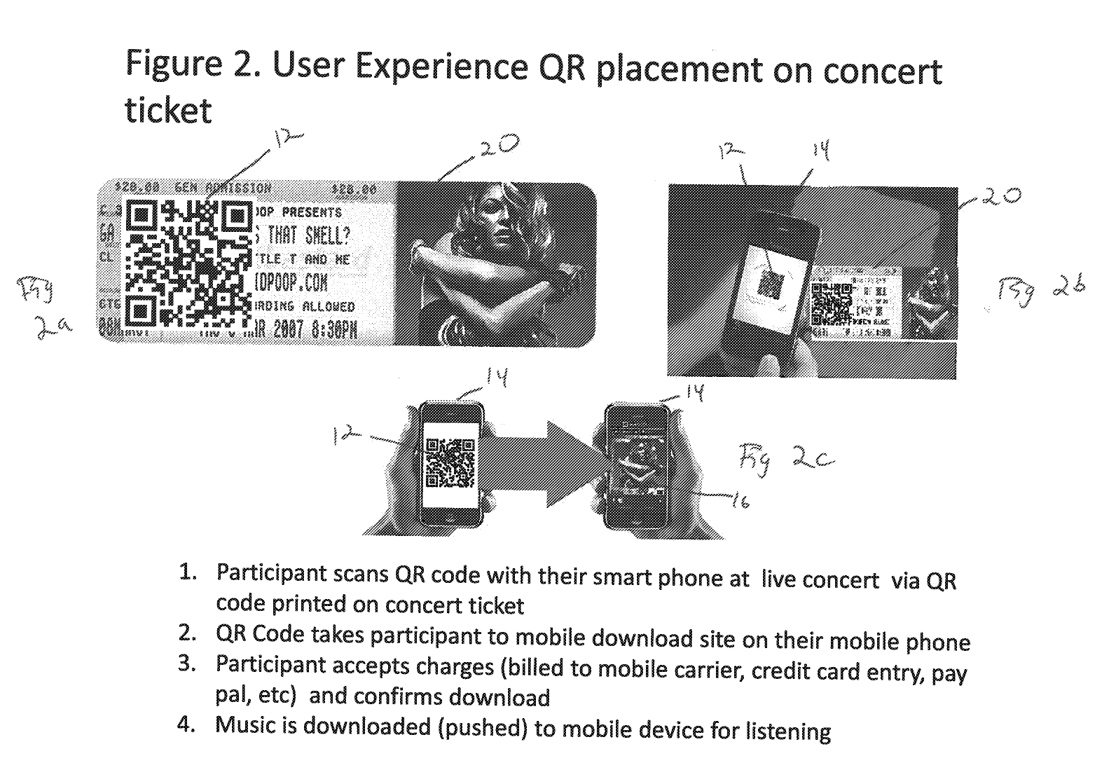

FIG. 2a shows an alternate embodiment of the present invention, showing a QR code 12 placed on a performance ticket 20, rather than on the large display screen 10. Like the first embodiment, this code will allow a user to download the live performance being heard while the performance is being attended. The website application may include a mechanism which allows activation and de-activation of the QR code, either by time or geography. This would prevent an individual from downloading the live performance without ever attending it (i.e. if one individual buys a ticket and shares the QR code scan with all of his friends). Through this mechanism, the QR code scan might only work, in one embodiment, and take a user to the site for download, either during the time of the performance (or directly thereafter, such as a period of 18 hours), or within a limited geographic range of the venue.

As shown in FIG. 2b, a user can use their mobile device 14 to scan the QR code 12 depicted on the performance ticket 20, which, as seen in FIG. 2c, will take the user to a link for the download of the performance. In both embodiments shown, a user can be taken first to a site which will ask for confirmation of payment of the download. While the payment for such download is not a requirement for the present invention, such implementation exists in the preferred embodiment. This can be done either through applying such charges to the user's mobile phone carrier bill, by input of credit card information, through a PayPal account, or other similar means. Once payment method is entered, a user can click Submit and confirm payment for the purchase. This will activate the link with the audio/video stream being heard and/or seen for instant download, either to the mobile device, or to iTunes for conversion onto a computer, iPod, or other device.

Both of the embodiments of the present invention as depicted in FIGS. 1a-1c and 2a-2c can include, in addition to the display of a QR code 12, a text redemption option or a vanity URL option, which gives users an option to text a specified code to a given number for the purchase of the live event being attended or to log on, via their mobile phone 14, to a website which will allow for the payment to be made in order to receive the live download. For example, the terms “Text: ‘drakeconcert’ to 8824 to accept charges and download this concert to your mobile device,” or visit www.______.com/artistname to download this concert” could be displayed on a ticket or large display screen. This would allow users without smart phones or with phones that do not have a scanner app to make use of the live download process as well. In an alternate embodiment of the present invention, the text redemption option or vanity URL may be used in lieu of the scannable QR code, for use by an event attendee who does not have a smart phone with which to scan the QR code, or a scanner application on their phone.

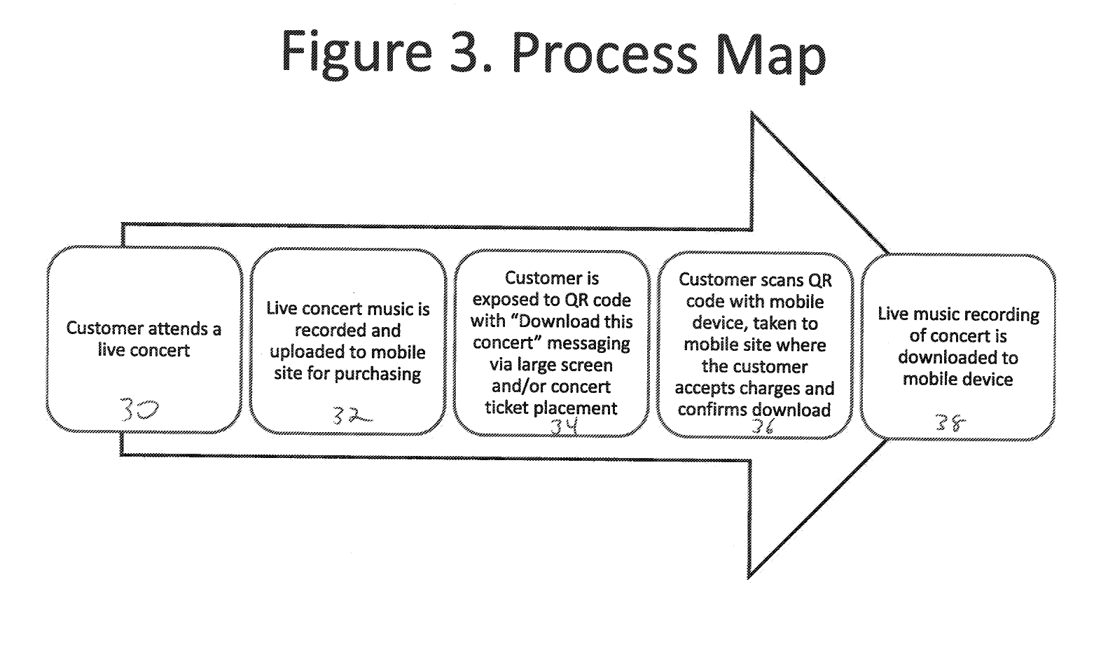

FIG. 3 depicts a schematic flowchart of the steps associated with the present invention, as described above. In step 30, a user must first attend a performance to make use of the present invention. Then, as shown in step 32, while at the performance, the live performance is recorded and uploaded to a server 40 for available purchase. A user at the performance can then scan a QR code displayed somewhere at the venue (on a screen, a ticket, etc.), as seen in step 34, which can direct users to scan in order to “Download This Concert.” Once scanned, the QR code will take a customer to a site for the download of the live performance, and if necessary, will first require the payment of a fee for the download by the customer, either through a credit card or PayPal or other means. This is shown in step 36. Once payment is made (if required), the user will be taken to site where the live concert performance can be downloaded directly to the mobile device, as shown in step 38.

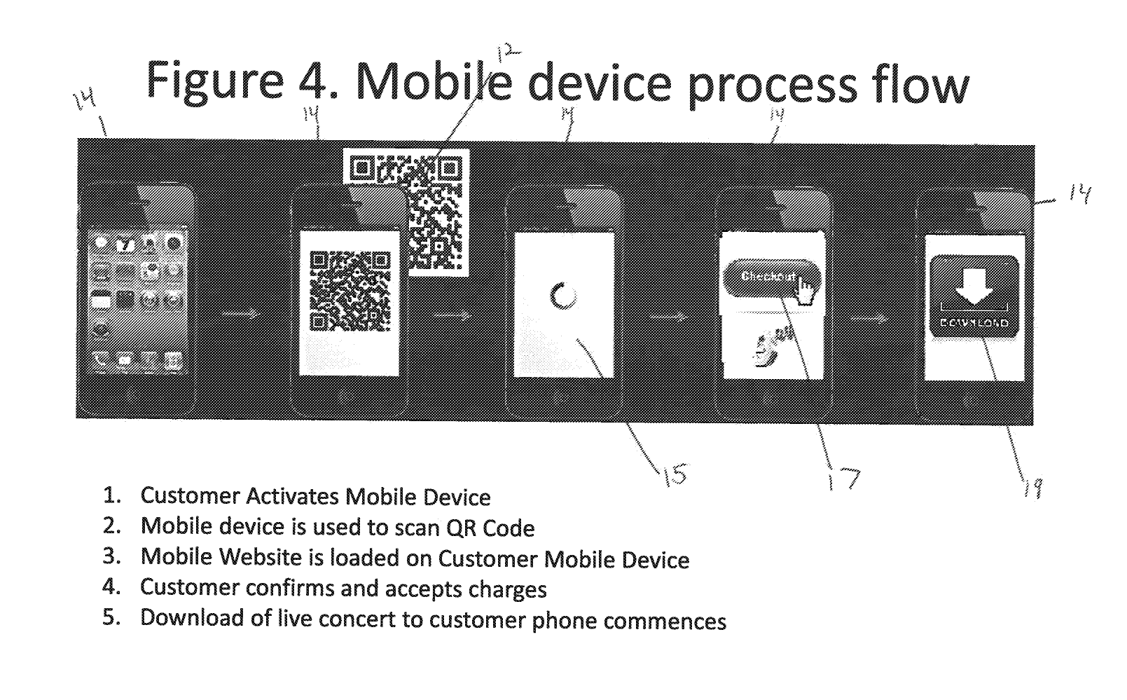

This process is also depicted in FIG. 4, showing the steps taken as seen through the mobile device. A mobile device 14 can scan a QR code 12 (potentially with the use of a scanner application as available for smartphones). The QR code can then take a user to a link 15 which allows a user to pay for the performance download. Once payment information has been entered, a user will be asked to “Checkout” 17, to finalize payment. Then the user will be taken to a website and can click “Download” 19 to record the live performance onto his or her mobile device. While the preferred embodiment of the present invention requires payment for the download as seen in step 17, this step may be skipped and the invention can allow a user to download the live performance without charge so long as the other applicable parameters are met (ie. proximity to the concert or during the time of, or immediately after, the performance).

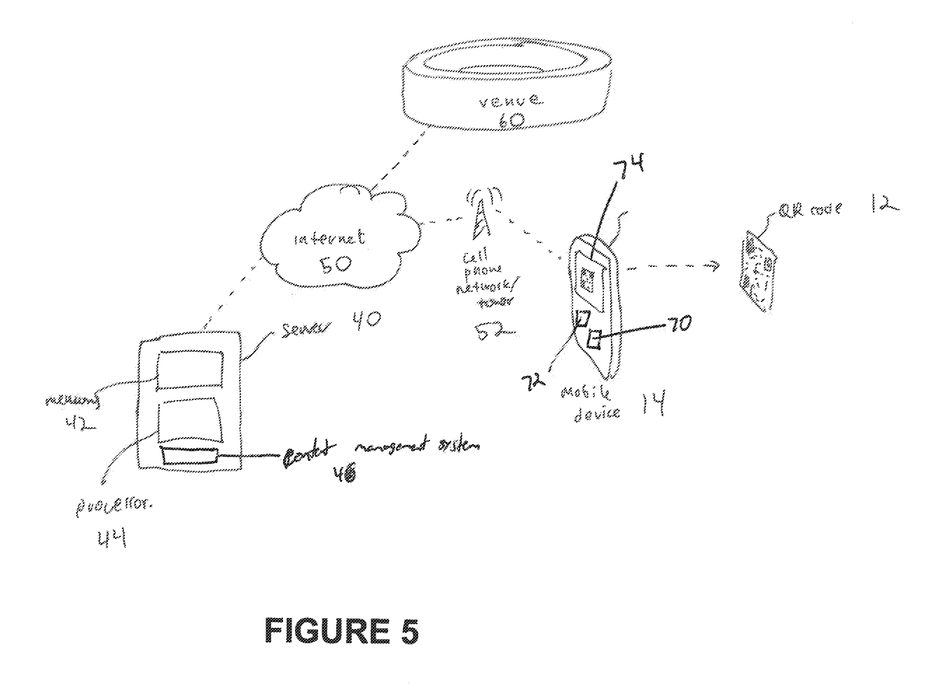

FIG. 5 is a schematic drawing of a system on which the present invention may be implemented, including the interaction between the QR code and the mobile device 14 through the internet or wireless network. As shown, mobile device 14 is adapted to scan, through scanner 74, a QR code 12. Mobile device 14 also contains a memory 70 and processor 72. The mobile device is also provided with software (not depicted) which is adapted to perform the download of the live performance. To ensure mobile device 14 is adapted to execute this function, it may be loaded with a QR recognition application.

Through the cell phone network 52, the mobile device 14 will connect to the internet 50. At the same or an earlier time, the venue 60, which is holding the live performance, connects, through the internet 50, to a server 40, which contains a memory 42 and a processor 44. The server 40 is adapted to hold, on a content management system 46, the downloaded live performance, which is recorded through the internet 50 from venue 60. The performance is downloaded and stored on memory 42. Once mobile device 14 has connected to internet 50 and scanned QR code 12, it can download, from the server 40, the stored live performance by means of processor 72 on the mobile device and processor 44 on the server.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A system for downloading a live performance held at a venue using a QR code, the system comprising:
a server, including a memory, a processor, and a content management system; and
a computer, including a memory, a processor, a scanner for inputting the QR code, and software;
wherein said content management system is stored in said memory of said server and is adapted to run on said processor of said server, and is configured to:
provide a website;
receive data pertaining to the live performance from the venue;
store said live performance data on said memory of said server;
transmit a link corresponding to said website to said computer;
receive information from said computer relating to the QR code; and
transmit said live performance data to said computer through the internet;
wherein said software is stored in said memory of said computer and is adapted to run on said processor of said computer, and is configured to:
scan an image of the QR code;
associate the QR code with said link for said download of said live performance;
communicate, through the internet, with said content management system;
receive, from said content management system, said data pertaining to the download of said live performance;
download said live performance data; and
store said live performance data in said memory of said computer.

2. A system for downloading a live performance as claimed in claim 1, wherein said content management system is further adapted to transmit a request for payment for said download of said live performance data to said computer.

3. A system for downloading a live performance as claimed in claim 2, wherein said payment is made by credit card.

4. A system for downloading a live performance as claimed in claim 2, wherein said payment is made by PayPal.

5. A system for downloading a live performance as claimed in claim 2, wherein said payment is charged to the wireless network provider associated with said computer.

6. A system for downloading a live performance as claimed in claim 1, wherein said computer is a mobile phone.

7. A system for downloading a live performance as claimed in claim 1, wherein said QR code is scanned from a large video screen.

8. A system for downloading a live performance as claimed in claim 1, wherein said QR code is scanned from a ticket.

9. A system for downloading a live performance as claimed in claim 1, wherein said QR code is scanned from a flyer handout.

10. A system for downloading a live performance as claimed in claim 1, wherein said link is substantially only accessible by scanning said QR code during said live performance.

11. A system for downloading a live performance as claimed in claim 1, wherein said data is audio.

12. A system for downloading a live performance as claimed in claim 1, wherein said data is video.

13. A system for downloading a live performance as claimed in claim 1, wherein said data is any other data associated with a live performance.

14. A system for downloading, from a server with memory, processor, and content management system, a live performance held at a venue using a QR code, the system comprising:
a computer, including a memory, a processor, a scanner for inputting a QR code, and software;
wherein said software is stored in said memory of said computer and is adapted to run on said processor of said computer, and is configured to:
scan an image of the QR code;
associate the QR code with said link for the download of said live performance;
communicate, through the internet, with a content management system;
receive, from a content management system, data pertaining to the download of said live performance;
download said live performance data; and
store said live performance data in said memory of said computer.

15. A system for downloading, onto a computer with memory, processor, and software, a live performance held at a venue using a QR code, the system comprising:
a server, including a memory, a processor, and a content management system;
wherein said content management system is stored in said memory of said server and is adapted to run on said processor of said server, and is configured to:
provide a website;
receive data pertaining to the live performance from the venue;
store said live performance data on said memory of said server;
transmit a link corresponding to said website to a computer;
receive information from a computer relating to the QR code; and
transmit said live performance data to a computer through the internet.

16. A method for downloading a live performance held at a venue using a QR code, comprising:
scanning, by a computer comprising a memory, processor, and software, the QR code;
providing, by a server comprising a memory, processor, and content management system, a website;
receiving, by said server, data pertaining to the live performance from the venue;
storing, by said server, said live performance data on said memory of said server;
transmitting, by said server to said computer, a link corresponding to said website;
associating, by said software, the QR code with a link for the download of said live performance;
communicating, by said software and through the internet, with said content management system;
receiving, by said content management system, information from said software relating to the QR code;
transmitting, by said content management system and through the internet, said live performance data to said computer;
receiving, by said software, said live performance data from a content management system;
downloading said live performance; and
storing said live performance data in said memory of said computer.

17. A method for downloading a live performance as claimed in claim 16, further comprising the step of requesting payment by a user for said download of said live concert performance.

18. A method for downloading a live performance as claimed in claim 17, wherein said payment is made by credit card.

19. A method for downloading a live performance as claimed in claim 17, wherein said payment is made by PayPal.

20. A method for downloading a live performance as claimed in claim 17, wherein said payment is charged to the wireless network provider associated with said computer.

21. A method for downloading a live performance as claimed in claim 16, wherein said computer is a mobile phone.

22. A method for downloading a live performance as claimed in claim 16, wherein said QR code is displayed on a large video screen.

23. A method for downloading a live performance as claimed in claim 16, wherein said QR code is displayed on a ticket.

24. A method for downloading a live performance as claimed in claim 16, wherein said QR code is displayed on a flyer handout.

25. A method for downloading a live performance as claimed in claim 16, wherein said web link is substantially only accessible by scanning said QR code during said live concert performance.

26. A method for downloading, from a server comprising a memory, processor, and content management system, a live performance held at a venue using a QR code, comprising:
scanning, by a computer comprising a memory, processor, and software, the QR code;
associating, by said software, the QR code with a link for the download of said live performance;
communicating, by said software and through the internet, with said content management system;
receiving, by said software, said live performance data from a content management system;
downloading said live performance; and
storing said live performance data in said memory of said computer.

27. A method for downloading, onto a computer comprising a memory, processor, and software, a live performance held at a venue using a QR code, comprising:
providing, by a server comprising a memory, processor, and content management system, a website;
receiving, by said server, data pertaining to the live performance from the venue;
storing, by said server, said live performance data on said memory of said server;
transmitting, by said server to said computer, a link corresponding to said website;
receiving, by said content management system, information from said software relating to the QR code; and
transmitting, by said content management system and through the internet, said live performance data to said computer.

28. A system for downloading a live performance as claim 1, wherein said content management system is further configured to receive information from said computer relating to a text message.

29. A system for downloading a live performance as claim 1, wherein said content management system is further configured to receive information from said computer relating to a URL.

30. A system for downloading a live performance as claim 14, wherein said server is further configured to receive a text message.

31. A system for downloading a live performance as claim 14, wherein said server is further configured to receive a URL.

32. A system for downloading a live performance as claim 15, wherein said content management system is further configured to receive information from said computer relating to a text message.

33. A system for downloading a live performance as claim 15, wherein said content management system is further configured to receive information from said computer relating to a URL.

34. A method for downloading a live performance as claim 16, further comprising entering, using an input device of said computer, a text message.

35. A method for downloading a live performance as claim 16, further comprising entering, using an input device of said computer, a URL.

36. A method for downloading a live performance as claim 26, further comprising entering, using an input device of said computer, a text message.

37. A method for downloading a live performance as claim 26, further comprising entering, using an input device of said computer, a URL.

38. A method for downloading a live performance as claim 27, receiving, by said content management system, a text message from the computer.

39. A method for downloading a live performance as claim 27, receiving, by said content management system, a URL from the computer.

40. A system for downloading a live performance held at a venue, the system comprising:
a server, including a memory, a processor, and a content management system; and
a computer, including a memory, a processor, and software;
wherein said content management system is stored in said memory of said server and is adapted to run on said processor of said server, and is configured to:
provide a website;
receive data pertaining to the live performance from the venue;
store said live performance data on said memory of said server;
transmit a link corresponding to said website to said computer;
receive information from said computer; and
transmit said live performance data to said computer through the internet;
wherein said software is stored in said memory of said computer and is adapted to run on said processor of said computer, and is configured to:
communicate, through the internet, with said content management system;
transmit, by means of an input device, download permission information to said content management system;
associate said download permission information with a link for the download of a live performance;
receive, from said content management system, said data pertaining to the download of said live performance;
download said live performance data; and
store said live performance data in said memory of said computer.

41. A system for downloading a live performance as claimed in claim 40, wherein said content management system is further adapted to transmit a request for payment for said download of said live performance data to said computer.

42. A system for downloading a live performance as claimed in claim 41, wherein said payment is made by credit card.

43. A system for downloading a live performance as claimed in claim 41, wherein said payment is made by PayPal.

44. A system for downloading a live performance as claimed in claim 41, wherein said payment is charged to the wireless network provider associated with said computer.

45. A system for downloading a live performance as claimed in claim 40, wherein said computer is a mobile phone.

46. A system for downloading a live performance as claimed in claim 40, wherein said link is substantially only accessible during said live performance.

47. A system for downloading a live performance as claimed in claim 40, wherein said data is audio.

48. A system for downloading a live performance as claimed in claim 40, wherein said data is video.

49. A system for downloading a live performance as claimed in claim 40, wherein said data is any other data associated with a live performance.

50. A system for downloading a live performance as claimed in claim 40, wherein said download permission information is a text message.

51. A system for downloading a live performance as claimed in claim 40, wherein said download permission information is a URL.

52. A system for downloading, from a server with memory, processor, and content management system, a live performance held at a venue, the system comprising:
a computer, including a memory, a processor, and software;
wherein said software is stored in said memory of said computer and is adapted to run on said processor of said computer, and is configured to:
communicate, through the internet, with a content management system;
transmit, by means of an input device, download permission information to said content management system;
associate said information with a link for the download of a live performance;
receive, from a content management system, data pertaining to the download of said live performance;
download said live performance data; and
store said live performance data in said memory of said computer.

53. A system for downloading, onto a computer with memory, processor, and software, a live performance held at a venue, the system comprising:
a server, including a memory, a processor, and a content management system;
wherein said content management system is stored in said memory of said server and is adapted to run on said processor of said server, and is configured to:
provide a website;
receive data pertaining to the live performance from the venue;
store said live performance data on said memory of said server;
transmit a link corresponding to said website to a computer;
receive download permission information from a computer relating; and
transmit said live performance data to a computer through the internet.

54. A method for downloading a live performance held at a venue, comprising:
providing, by a server comprising a memory, processor, and content management system, a website;
receiving, by said server, data pertaining to the live performance from the venue;
storing, by said server, said live performance data on said memory of said server;
entering, by means of an input device on a computer comprising a memory, processor, and software, download permission information;
transmitting, by said server to said computer, a link corresponding to said website;
associating, by said software, said download permission information with a link for the download of said live performance;
communicating, by said software and through the internet, with said content management system;
receiving, by said content management system, download permission information from said software;
transmitting, by said content management system and through the internet, said live performance data to said computer;
receiving, by said software, said live performance data from a content management system;
downloading said live performance; and
storing said live performance data in said memory of said computer.

55. A method for downloading a live performance as claimed in claim 54, further comprising the step of requesting payment by a user for said download of said live concert performance.

56. A method for downloading a live performance as claimed in claim 55, wherein said payment is made by credit card.

57. A method for downloading a live performance as claimed in claim 55, wherein said payment is made by PayPal.

58. A method for downloading a live performance as claimed in claim 55, wherein said payment is charged to the wireless network provider associated with said computer.

59. A method for downloading a live performance as claimed in claim 54, wherein said computer is a mobile phone.

60. A method for downloading a live performance as claimed in claim 54, wherein said web link is substantially only accessible during said live concert performance.

61. A method for downloading, from a server comprising a memory, processor, and content management system, a live performance held at a venue, comprising:
entering, by means of an input device on a computer comprising a memory, processor, and software, download permission information;
associating, by said software, said download permission information with a link for the download of said live performance;
communicating, by said software and through the internet, with said content management system;
receiving, by said software, said live performance data from a content management system;
downloading said live performance; and
storing said live performance data in said memory of said computer.

62. A method for downloading, onto a computer comprising a memory, processor, and software, a live performance held at a venue, comprising:
providing, by a server comprising a memory, processor, and content management system, a website;
receiving, by said server, data pertaining to the live performance from the venue;
storing, by said server, said live performance data on said memory of said server;
transmitting, by said server to said computer, a link corresponding to said website;
receiving, by said content management system, download permission information from said software; and
transmitting, by said content management system and through the internet, said live performance data to said computer.

63. A system for downloading a live performance as claim 52, wherein said download permission information relates to a text message.

64. A system for downloading a live performance as claim 52, wherein said information relates to a URL.

65. A system for downloading a live performance as claim 53, wherein said download permission information relates to a text message.

66. A system for downloading a live performance as claim 53, wherein said download permission information relates to a URL.

67. A method for downloading a live performance as claim 54, wherein said download permission information relates to a text message.

68. A method for downloading a live performance as claim 54, wherein said download permission information relates to a URL.

69. A method for downloading a live performance as claim 61, wherein said download permission information relates to a text message.

70. A method for downloading a live performance as claim 61, wherein said download permission information relates to a URL.

71. A method for downloading a live performance as claim 62, wherein said download permission information relates to a text message.

72. A method for downloading a live performance as claim 62, wherein said download permission information relates to a URL.
